(19) United States
(12) Patent Application Publication
(10) Pub. No.: US 2009/0314732 A1
(43) Pub. Date: Dec. 24, 2009

(54) Crane-Luffing Cylinder Bearing with a Spherical Calotte

(76) Inventors: JAN BRINKMANN, OLDENBURG (DE); DIETER STUEHRWOLDT, WILHELMSHAVEN (DE)

Correspondence Address: MIDDLETON & REUTLINGER, 2500 BROWN & WILLIAMSON TOWER, LOUISVILLE, KY, 40202, US

(21) Appl. No.: 12/482,868

(22) Filed: Jun. 11, 2009

(30) Foreign Application Priority Data
Jun. 19, 2008 (DE) 102008029116.1-22

(51) Int. Cl. B66C 23/82; F16C 23/02

(52) U.S. Cl. 212/253; 384/440

(57) ABSTRACT

The invention relates to the bearing system of a luffing cylinder (1) of a crane, in particular a mobile crane, and the luffing cylinder (1) is connected to a bearing point on the crane by at least one of its ends by means of a spherical calotte-shaped bearing (2, 3).

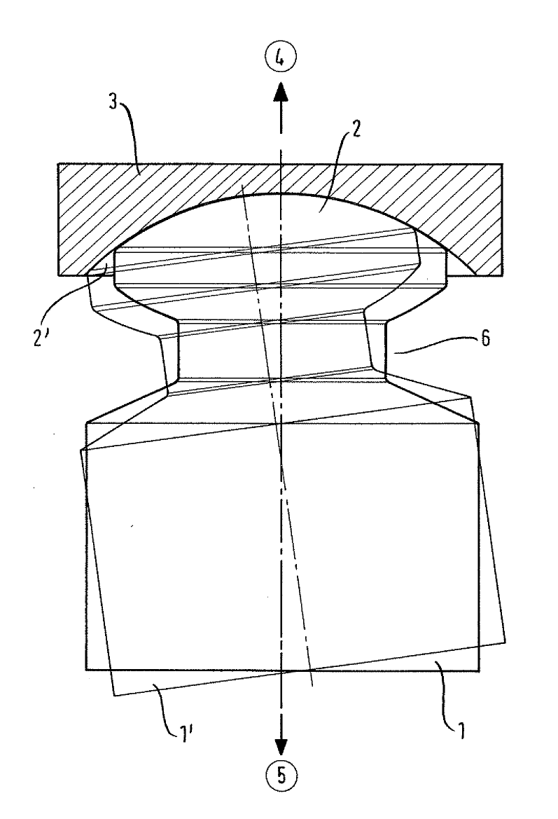

The invention relates to the bearing of a luffing cylinder of a crane, in particular a mobile crane.

The luffing cylinder of such a crane is a hydraulic cylinder, which is disposed between a point on the crane base (in the case of mobile cranes on the slewing ring for example) and a bearing point on the crane jib and ensures that the jib is righted as it is extracted.

The luffing cylinder is one of the main components of a mobile crane structure. It must function perfectly; in particular it must not jolt during operation. Steps must be taken to ensure that the cylinder is retracted and extracted uniformly because the crane can not be operated uniformly otherwise, and in addition, the cylinder force can not be measured cleanly as an input value for limiting the load torque unless the cylinder is running as far as possible without friction (and also without jolting). The design and mounting of this luffing cylinder is therefore of utmost importance.

A problem can occur, especially in the event of lateral deformation of the jib. To ensure that the luffing cylinder is not distorted and can therefore operate without problems and the guide belts in the cylinder are protected against damage, the upper links on the jib used in the prior art are usually of an articulated design and articulated joints are often used for this purpose. These joints enable the luffing cylinder to operate irrespective of lateral deformation of the jib. As new materials become available and jib systems become ever longer, lateral deformation of future jib systems will become increasingly problematic. The effect this will have on the luffing cylinder will therefore be even more important.

Accordingly, the objective of this invention is to propose a bearing for a crane luffing cylinder, which is able to meet the increasingly high demands of the future as described above. In particular, the objective is to provide a stable bearing which will guarantee problem-free running of the luffing cylinder—even in the event of lateral deformation.

This objective is achieved by the invention on the basis of a luffing cylinder bearing for a crane, in particular a mobile crane, as defined in claim 1. The dependent claims define preferred embodiments of the invention.

As proposed by the invention, the luffing cylinder is connected by at least one of its ends to a bearing point on the crane by means of a spherical calotte-shaped bearing. The spherical calotte-shaped bearing is of an optimum design in terms of the loads which occur and in particular it does not transmit the forces and torques which occur as a result of lateral deformation of the jib to the luffing cylinder, thereby enabling it to operate without problems and in an optimum manner. This also applies in particular in the case of relatively pronounced lateral deformations, during which the calotte-shaped bearing continues to afford sufficient hold but is only able to transmit compression forces.

The spherical calotte-shaped bearing proposed by the invention also plays a part in meeting the demand for a lightweight construction. Additional increases in load-bearing capacity can not be achieved unless the individual components offer higher performance for the same weight. The designs used to date have been judged somewhat difficult in terms of assembly, whereas the spherical calotte-shaped bearing proposed by the invention offers a design which can be assembled very easily.

Moreover, the cylinder is limited in terms of its stroke and its mounting length whereas existing bearing solutions, especially those based on articulated joints for compensating lateral deformations, are of a considerable mounting length, which in turn has a decisive influence on the “dead length” not available for the stroke. All of these problems are simultaneously overcome by the bearing system proposed by the invention because the spherical calotte-shaped bearing represents a very short bearing system which is easy to fit.

The bearing point of the luffing cylinder with which the spherical calotte-shaped bearing is provided as proposed by the invention is preferably a bearing point on the crane jib; in principle, however, it may also be a bearing point on the crane base, in particular on the slewing ring of a mobile crane. In this respect, it should be pointed out that, in the context of this invention, it would theoretically also be possible to provide the spherical calotte-shaped bearing on both bearing points of the luffing cylinder although in a preferred embodiment, the spherical calotte-shaped bearing is provided at only one end of the luffing cylinder, preferably the jib end, whilst the other end is mounted by means of a knuckle type bearing (or “bolt bearing”).

In one embodiment, the spherical calotte-shaped bearing itself may comprise a spherical calotte and a bearing shell and various different options are possible. The spherical calotte constitutes the concave part of the bearing and its partially spherical shape is exactly adapted to the “inner sphere”, in other words the convex part, of the bearing shell. In one variant, the spherical calotte is disposed at the luffing cylinder end and the bearing shell is disposed on the crane bearing point, i.e. on the crane side. In the other variant, the spherical calotte is disposed on the crane side and the bearing shell on the luffing cylinder side.

The spherical calotte-shaped bearing may additionally be provided with a tension lock even though it is a component which is primarily subjected to compression. The tension lock may have retaining elements which are attached to or locate in both sides of the bearing point, in particular brackets, retaining rods, locking plates or cable stays or other components which act as a tension lock. In the case of one design option, the tension lock has a fastener or locating element at the spherical calotte end, in particular a recess, a circumferential groove or an indentation or undercut.

The invention will be explained in detail below with reference to an example of an embodiment illustrated in the single appended drawing. It may incorporate all the described features, either individually or in any practical combination. The drawing provides a schematic illustration of the main elements of the luffing cylinder bearing.

Reference number 1 in the drawing is used to denote the luffing cylinder, which has a circumferential groove 6 at its top end and a spherical calotte 2 adjoining it. The spherical calotte 2 is mounted in the bearing shell 3, which is disposed on the jib, the jib-bearing point being only schematically indicated by reference 4. Reference number 5 points to the bottom part of this cylinder towards its second bearing point on the crane base. The lighter coloured shading shows the luffing cylinder in a position still pivoted by a few degrees (in this instance 8° ), in which it is able to absorb compression forces without having to withstand distorting forces or torques.

The drawing illustrates the upper connection of the luffing cylinder 1 to the jib 4 with the spherical calotte 2 and bearing shell 3. As mentioned above, the design may also be the reverse (calotte on the jib; shell on the luffing cylinder). The possible pivot range at the luffing cylinder linkage point is approximately up to ±10°, especially approximately up to ±5°, depending on the crane. The design of the shell radius is the same as that of the calotte 2, and the start and the end are defined by the uppermost and lowermost position of the luffing cylinder 1. The calotte 2 and the shell 3 are of a rounded or circular symmetrical design, i.e. across 360°, as a result of which the luffing cylinder 1 is able to compensate a rotating movement in every axis, in particular a rotating movement of the jib 4.

This design proposed by the invention is possible because the luffing cylinder 1 is a component which is subjected to compression. The cylinder is not subjected to tensile forces except during dolly operation, in other words when the jib is pre-tensioned by means of a trailer in order to reduce the maximum axial load. The forces which occur are only a fraction of the maximum compression force which occurs and the forces can therefore be more easily transmitted. As proposed by the invention, the calotte system is preferably secured by means of retaining rods (brackets) and locking plates mounted on them, which are able to locate behind the calotte 2 in the circumferential groove 6, thereby enabling tensile force to be absorbed.

With this system proposed by the invention, the luffing cylinder can be integrated without any constraints with respect to the jib at all, and jib deformations do not cause any forced torques to be transmitted to the piston rod and hence the guide belts of the cylinder. The dead length can be significantly reduced because the spherical calotte is of a very short construction, thereby reducing the weight and mounting length. Production is relatively simple, thereby reducing costs as well as weight. Assembly of the crane is made easier because there are no bearing bolts which have to be aligned; the bearing shell is simply placed on the cylinder, i.e. on the calotte.

Another major advantage resides in the fact that the surface available for transmitting loads to the cylinder (compared with the knuckle bolts known from the prior art) is relatively large. This means that simple materials, preferably materials which are easy to produce and in particular also plastics, may be used as the material for the shell or may be used as materials on the cylinder end in the region of the calotte.

1. A bearing of a luffing cylinder (1) for a crane, in particular a mobile crane, characterised in that the luffing cylinder (1) is connected by at least one of its end to a bearing point on the crane by means of a spherical calotte-shaped bearing (2, 3).

2. The bearing of a luffing cylinder for a mobile crane as claimed in claim 1, characterised in that the bearing point is a bearing point on the crane jib (4).

3. The bearing of a luffing cylinder for a mobile crane as claimed in claim 1, characterised in that the bearing point is a bearing point on the crane base (5), in particular on the slewing ring of a mobile crane.

4. The bearing of a luffing cylinder for a mobile crane as claimed in one of claim 1, characterised in that the spherical calotte-shaped bearing has a spherical calotte (2) and a bearing shell (3), and the spherical calotte (2) is disposed at the luffing cylinder end and the bearing shell (3) is disposed on the crane at the bearing point.

5. The bearing of a luffing cylinder for a mobile crane as claimed in one of claim 1, characterised in that the spherical calotte-shaped bearing has a spherical calotte (2) and a bearing shell (3), and the spherical calotte (2) is disposed on the crane at the bearing point and the bearing shell (3) is disposed at the luffing cylinder end.

6. The bearing of a luffing cylinder for a mobile crane as claimed in one of claim 1, characterised in that the spherical calotte-shaped bearing (2, 3) is additionally provided with a tension lock.

7. The bearing of a luffing cylinder for a mobile crane as claimed in claim 6, characterised in that the tension lock has fastener or locating retaining elements on either side of the bearing point, in particular one or more of the following:
brackets,
retaining rods,
lock plates or
cable stays.

8. The bearing of a luffing cylinder for a mobile crane as claimed in claim 6, characterised in that the tension lock has a fastener or locating element at the spherical calotte end, in particular a recess, a circumferential groove (6) or an indentation or undercut.

9. The bearing of a luffing cylinder for a mobile crane as claimed in one of claim 1, characterised in that the spherical calotte-shaped bearing (2, 3) is provided at only one end of the luffing cylinder, preferably at the jib end, whilst the other end, preferably the base end, is mounted by means of a knuckle-type bearing, in particular a bolt bearing.

10. A luffing cylinder bearing for a mobile crane, comprising:
a luffing cylinder supported on a mobile crane base at a lower end of said luffing cylinder, said cylinder having a spherical calotte at an upper end;
a bearing shell disposed on a jib of said metal crane wherein said calotte is a spherical calotte, said bearing shell spherically matched to receive said spherical calotte;
said luffing cylinder having a circumference groove interposed between said upper end and said lower end;
wherein said cylinder is supported on a bearing point on a slewing ring of said mobile crane and said bearing on said jib at a bearing point.

11. A luffing cylinder bearing for a mobile crane, comprising:
a luffing cylinder supported on a mobile crane base at a lower end of said luffing cylinder, said cylinder having a spherical calotte at an upper end;
a bearing shell disposed on a jib of said metal crane wherein said calotte is a spherical calotte, said bearing shell spherically matched to receive said spherical calotte;
said luffing cylinder having a circumference groove interposed between said upper end and said lower end;
wherein said cylinder is supported on a bearing point on a slewing ring of said mobile crane and said bearing on said jib at a bearing point;
a tension lock having retaining elements attached to both sides of said bearing point, said tension lock having a fastener at said circumferential groove of said luffing cylinder.
